(19) United States
(12) Patent Application Publication
(10) Pub. No.: US 2007/0147652 A1
(43) Pub. Date: Jun. 28, 2007

(54) Speaker device

(75) Inventors: Koji Takayama, Yamagata (JP); Kazuki Yuze, Yamagata (JP); Hiroyuki Kobayashi, Yamagata (JP); Shinichi Hayasaka, Yamagata (JP)

Correspondence Address: ARENT FOX PLLC, 1050 CONNECTICUT AVENUE, N.W., SUITE 400, WASHINGTON, DC, 20036, US

(73) Assignees: PIONEER CORPORATION; TOHOKU PIONEER CORPORATION

(21) Appl. No.: 11/644,990

(22) Filed: Dec. 26, 2006

(30) Foreign Application Priority Data
Dec. 26, 2005 (JP) 2005-373233

(51) Int. Cl. H04R 9/06

(52) U.S. Cl. 381/396

(57) ABSTRACT

It is an object of the present invention to provide an improved speaker device equipped with a long plate, capable of realizing a high flux density within the magnetic gap without forming any un-useful space. The speaker device has a magnetic circuit including a yoke integrally formed with a center pole and a bottom yoke; an annular magnet; and an annular top plate. A voice coil wound around a voice coil bobbin fixed with a diaphragm is freely vibratably supported in the axial direction of the center pole within the magnetic gap g formed between the center pole and the yoke. Moreover, the speaker device has a first magnet having a first inner diameter and disposed on the bottom yoke, and a second magnet having a second inner diameter larger than the first inner diameter and disposed on the first magnet. The top plate has a radial direction rectangular section portion, and a cylindrical bent portion facing between the inner circumferential surface of the second magnet and the center pole.

### BACKGROUND OF THE INVENTION

The present invention relates to a speaker device.

The present application claims priority from Japanese Application No. 2005-373233, the disclosure of which is incorporated herein by reference.

With regard to a speaker device having an external magnetism type magnetic circuit, there has been known one equipped with a so-called long plate, in which part of a plate serving as essential element for the magnetic circuit and facing a magnetic gap has a larger width than a winding width of a voice coil disposed within the magnetic gap, thereby improving a vibration linearity (refer to Japanese Unexamined Patent Application Publication No. Hei 6-327095). In the following, a description will be given to explain a detailed example of a speaker device equipped with a long plate with reference to FIG. 1.

As shown, this conventional speaker device has a magnetic circuit formed by disposing a plate 5j through a magnet 4j onto a yoke base 2j of a yoke 3j formed integrally with a center pole 1j. A frame 9j is installed on the plate 5j. A diaphragm 10j is disposed between an edge member 12j connected with a frame 9j on one hand and a cylindrical voice coil bobbin 6j on the other. A ring-shaped canceling magnet 16j is provided under the yoke 3j. Here, the voice coil bobbin 6j is held by a damper 8j, and a voice coil 7j is installed by winding itself around the voice coil bobbin 7j. Such a voice coil 7j is disposed in a magnetic gap G formed between the plate 5j and a center pole 1j in a manner such that the voice coil 7j can freely vibrate in the axial direction of the speaker device. In this way, a signal current can flow through a terminal section (not shown) to the voice coil 7j. As a result, by virtue of an electromagnetic force generated in the voice coil 7j, the voice coil 7j will be moved in the axial direction (z-axis direction) in connection with a flux of the magnet 4j. Actually, the movement of the voice coil 7j will propagate as a vibration of the diaphragm and can be outputted to an outside system as an acoustic output.

As shown in FIG. 1, the above-discussed magnetic circuit has an integrally bent top plate 5j, part of which facing the magnetic gap G has a width larger than the thickness of a bonded portion of the magnet, and has a thickness thinner than other portions of the plate. The voice coil 7j, which has a winding width smaller than the width of a part of the magnetic circuit facing the magnetic gap G, is disposed within the magnetic gap G. In this way, since the width of a part of the magnetic circuit facing the magnetic gap G is large and thus a uniform flux density distribution is formed in a large area, the voice coil can vibrate within such a uniform flux density distribution even if there is a large sound volume input, thereby reducing a distortion mainly caused due to an un-symmetric flux density distribution.

Regarding a speaker device having the above-described structure, since the above-discussed plate is formed in a relatively large width along the axial direction, it is possible to form a uniform flux density distribution through a large area within the magnetic gap. However, such an arrangement will result in a low flux density and thus a low driving force for driving the diaphragm 10j. Consequently, manufacturing cost will be high if simply using a magnet 4j having a large magnetic force. On the other hand, if a plurality of magnets 4j having the same shape are placed one above another, there will be a problem that an un-useful space is formed between the inner circumferential surfaces of the magnets and the center pole 1j.

Moreover, with regard to the foregoing conventional speaker device, when a signal current containing a high frequency component flows into the foregoing voice coil, an AC flux will be generated from the voice coil if the high frequency component has a frequency which is for example 100 Hz or more. In fact, such an AC flux will be collected in the vicinity of the magnetic gap G, particularly in the center pole 1j and the plate 5j near the magnetic gap G. Conventionally, materials forming the center pole 1j and the plate 5j have, as their magnetic characteristic, a non-linearity such as a hysteretic loop (minor loop). For this reason, an eddy current generated due to the AC flux will receive an influence based on the minor loop, and a distortion will occur in the current flowing into the voice coil, thus causing a distortion in a reproduced sound. Such a distortion based on an AC flux is particularly large in a speaker device equipped with a long plate having the above-described structure.

The present invention makes it one of its tasks to solve the above problem. Namely, it is an object of the present invention to provide an improved speaker device equipped with a long plate, capable of realizing a high flux density within the magnetic gap without causing any un-useful space, thereby reducing a distortion based on an AC flux and thus reducing a distortion in a reproduced sound.

### SUMMARY OF THE INVENTION

In order to achieve the foregoing object, the present invention is characterized by at least the following aspects.

According to one aspect of the present invention, there is provided a speaker device having a magnetic circuit including: a yoke integrally formed with a center pole uprightly standing in a generally central position of the speaker device and a bottom yoke extending outwardly in a radial direction from a base end of the center pole; an annular magnet provided concentrically with the center pole on the bottom yoke; and an annular plate disposed on the annular magnet. A voice coil wound around a voice coil bobbin fixed with a diaphragm is freely vibratably supported in an axial direction of the center pole within a magnetic gap formed between the center pole and the yoke. The magnet includes a first annular magnet having a first inner diameter and disposed on the bottom yoke, and a second annular magnet having a second inner diameter larger than the first inner diameter and disposed on the first annular magnet. The plate has a cylindrical bent portion bending from a radial direction rectangular section portion having a surface facing the second annular magnet, and facing between an inner circumferential surface of the second annular magnet and the center pole, and separated a predetermined interval from the inner circumferential surface of the second annular magnet. A part of the bent portion of the plate facing the magnetic gap is formed along the center axis in a length longer than a winding width of the voice coil. A front end of the bent portion is disposed from the vicinity of a plate side corner portion of an inner edge portion of the first annular magnet, and located on the plate side by being separated a predetermined interval from the corner portion.

According to another aspect of the present invention, there is provided another speaker device having a magnetic circuit including: a yoke integrally formed with a center pole uprightly standing in a generally central position of the speaker device and a bottom yoke extending outwardly in a radial direction from a base end of the center pole; an annular magnet provided concentrically with the center pole on the bottom yoke; and an annular plate disposed on the annular magnet. A voice coil wound around a voice coil bobbin fixed with a diaphragm is freely vibratably supported in an axial direction of the center pole within a magnetic gap formed between the center pole and the yoke. The plate has a cylindrical bent portion bending from a radial direction rectangular section portion having a surface facing the magnet, and facing between an inner circumferential surface of the magnet and the center pole, and separated a predetermined interval from the inner circumferential surface of the magnet. Apart of the bent portion of the plate facing the magnetic gap is formed along the center axis in a length longer than a winding width of the voice coil. A short-circuit ring formed of a non-magnetic conductive material is provided on part of the plate facing the magnetic gap and/or on the outer peripheral surface of the center pole.

### BRIEF DESCRIPTION OF THE DRAWINGS

These and other objects and advantages of the present invention will become clear from the following description with reference to the accompanying drawings, wherein:

FIG. 1 is a half sectional view showing a detailed example of a conventional speaker device having a long plate;

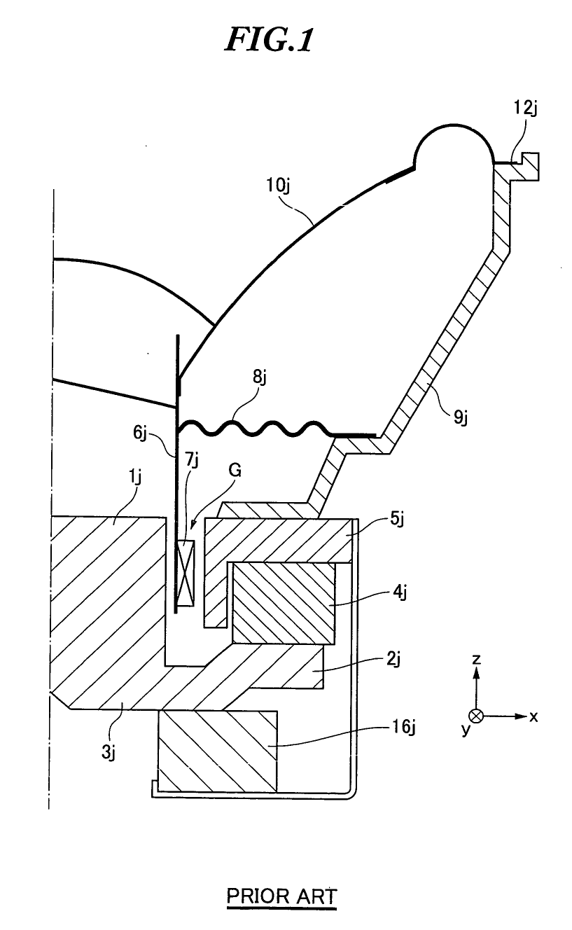

FIG. 2 is a sectional view showing a speaker device formed according to a first embodiment of the present invention;

FIG. 3 is an enlarged view showing an area near a center pole of the speaker device shown in FIG. 2;

FIG. 4 provides views illustrating a top plate of the speaker device 100 shown in FIGS. 2 and 3, FIG. 4A is an exploded perspective view of the plate and FIG. 4B is a perspective view showing an assembled plate;

FIG. 5 is a cross sectional view showing a speaker device 100a formed according to a second embodiment of the present invention;

FIG. 6 provides graphs showing a vibrating amount and a frequency characteristic of a speaker device formed according to one embodiment of the present invention and those of a conventional speaker device, FIG. 6A is a graph showing a vibrating amount of a diaphragm from a standard position in the speaker device formed according to the second embodiment of the present invention, FIG. 6B is a graph showing a vibrating amount of a diaphragm from a standard position in a conventional speaker device;

FIG. 7 shows acoustic frequency characteristics of speaker devices, FIG. 7A shows an acoustic frequency characteristic of a conventional speaker device, and FIG. 7B shows an acoustic frequency characteristic of a speaker device of the present invention; and

FIG. 8 is a sectional view showing a speaker device 100b formed according to another embodiment of the present invention.

### DETAILED DESCRIPTION OF THE PREFERRED EMBODIMENTS

The speaker device according to one embodiment of the present invention has a magnetic circuit including: the yoke integrally formed with the center pole uprightly standing in a generally central portion of the speaker device and the bottom yoke extending outwardly in the radial direction from the base end of the center pole; the annular magnet provided concentrically with the center pole on the bottom yoke; and the annular top plate disposed on the magnet. The voice coil wound around the voice coil bobbin fixed with the diaphragm is freely vibratably supported in the axial direction of the center pole within the magnetic gap formed between the center pole and the yoke. The foregoing magnet includes a first annular magnet having a first inner diameter and disposed on the bottom yoke, and a second annular magnet having a second inner diameter larger than the first inner diameter and disposed on the first annular magnet. The top plate has a cylindrical bent portion bending from a radial direction rectangular section portion having a surface facing the second annular magnet, and facing between the inner circumferential surface of the second annular magnet and the center pole, and separated a predetermined interval from the inner circumferential surface of the second annular magnet. A part of the bent portion of the top plate facing the magnetic gap is formed along the center axis (forming a so-called long plate structure) in a length longer than a winding width of the voice coil. Further, a front end of the bent portion is disposed from the vicinity of a plate side corner portion of an inner edge portion of the first annular magnet, and located on the plate side by being separated a predetermined interval from the corner portion.

In the speaker device having the above-described structure, the first and second annular magnets having different inner diameters are placed on the bottom yoke. The top plate has a cylindrical bent portion bending from a radial direction rectangular section portion having a surface facing the second annular magnet, and facing between the inner circumferential surface of the second annular magnet and the center pole, and separated a predetermined interval from the inner circumferential surface of the second annular magnet. The front end of the bent portion is disposed from the vicinity of a plate side corner portion of an inner edge portion of the first annular magnet, and located on the plate side by being separated a predetermined interval from the corner portion. In this way, it is possible to improve a space efficiency of the magnetic circuit, without forming an un-useful space within the magnetic circuit. Besides, even if the speaker device employs a long plate, it is still possible to realize a high flux density within the magnetic gap of the magnetic circuit.

The speaker device according to another embodiment of the present invention has a magnetic circuit including: the yoke integrally formed with the center pole uprightly standing in a generally central portion of the speaker device and the bottom yoke extending outwardly in the radial direction from the base end of the center pole; the annular magnet provided concentrically with the center pole on the bottom yoke; and the annular top plate disposed on the magnet. The voice coil wound around the voice coil bobbin fixed with the diaphragm is freely vibratably supported in the axial direction of the center pole within the magnetic gap formed between the center pole and the yoke. The top plate has a cylindrical bent portion bending from a radial direction rectangular section portion having a surface facing the annular magnet, and facing between the inner circumferential surface of the annular magnet and the center pole, and separated a predetermined interval from the inner circumferential surface of the annular magnet. A part of the bent portion of the top plate facing the magnetic gap is formed along the center axis in a length longer than a winding width of the voice coil. At this time, a short-circuit ring formed of a non-magnetic material is provided on part of the top plate facing the magnetic gap g and/or on the outer peripheral surface of the center pole.

In the speaker device having the foregoing structure, since a short-circuit ring formed of a non-magnetic material is provided on part of the top plate facing the magnetic gap g and/or on the outer peripheral surface of the center pole, even if a so-called long plate is used, the short-circuit ring can make it possible to reduce a distortion based on an AC flux, thereby reducing a distortion in a reproduced sound.

In the following, description will be given to explain a speaker device formed according to one embodiment of the present invention, with reference to the accompanying drawings.

### First Embodiment

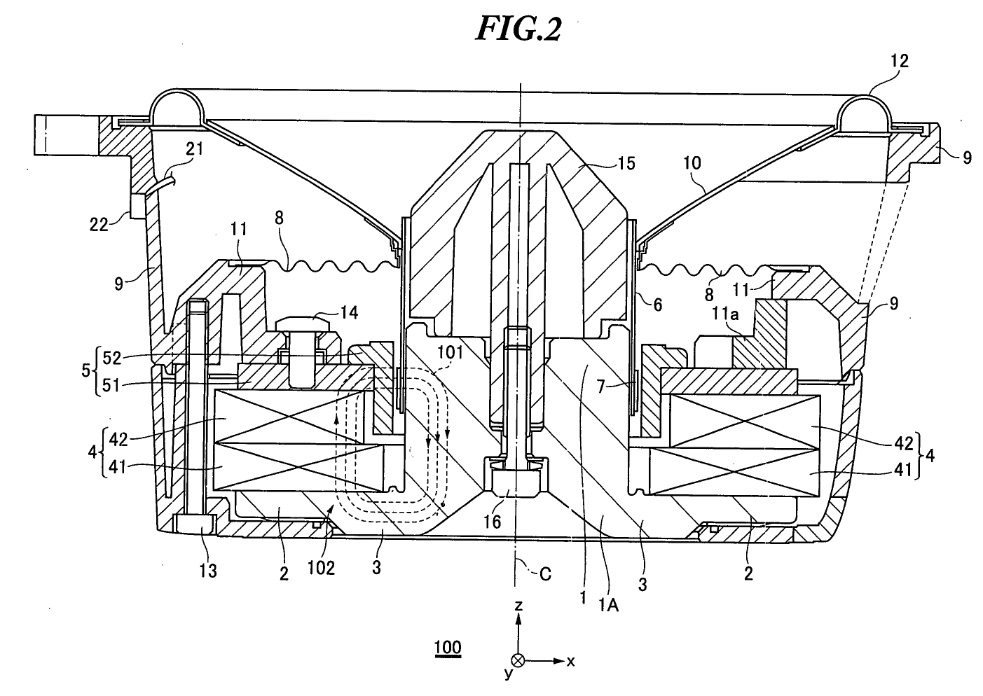

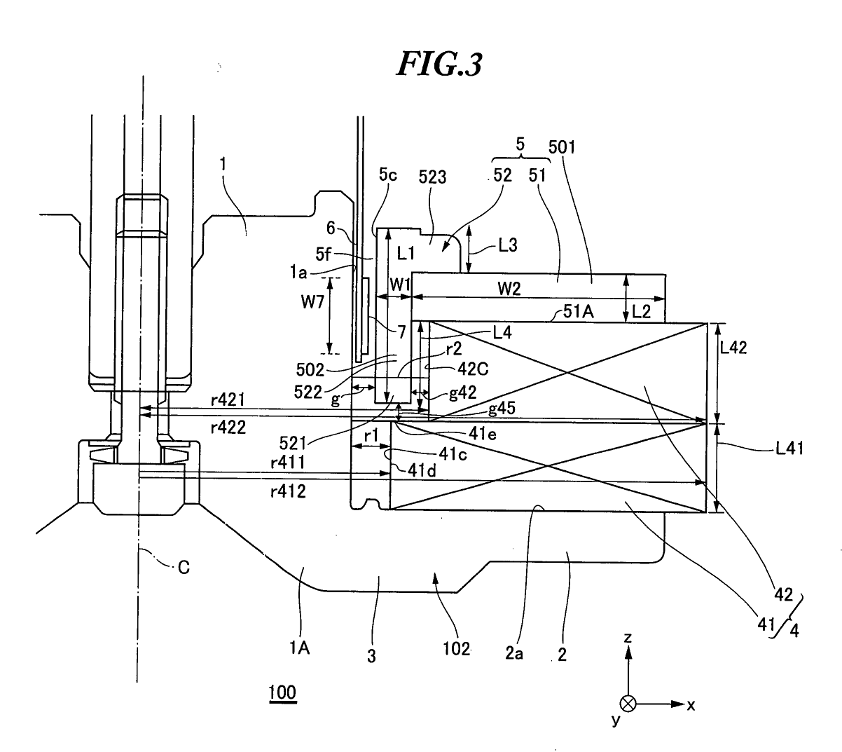

FIG. 2 is a sectional view showing a speaker device 100 formed according to a first embodiment of the present invention. FIG. 3 is an enlarged view showing an area near the center pole of the speaker device shown in FIG. 2. As shown in FIGS. 2 and 3, the speaker device 100 of the present embodiment comprises: a yoke 3 integrally formed with a center pole 1 uprightly standing in a generally central position of the speaker device 100 and a bottom yoke 2 extending in the radial direction from the base end 1A of the center pole 1; an annular magnet 4 which is a permanent magnet provided coaxially around the center pole 1; and a top plate 5 formed coaxially around the center pole 1 and disposed over the magnet 4, thus forming an outer diameter side flux applying section. In this way, the yoke 3, the magnet 4 and the center pole 1 together form a magnetic circuit 102 which generates a flux 101 (FIG. 2 shows only the left side flux 101). Further, a part of the center pole 1 facing the top plate 5 can serve as an equivalent to an inner diameter side flux applying section. Moreover, the magnetic circuit 102 has formed a magnetic gap g between the outer peripheral surface 1a of the center pole 1 and the inner circumferential surface 5c of the top plate 5. The top plate 5 of the present embodiment includes a first piece 51 and a second piece 52. The magnet 4 of the present embodiment includes a first magnet piece 41 and a second magnet piece 42. These elements will be described in more detail later. Here, the magnet 4 is an equivalent to one embodiment of the magnet of the present invention. The top plate 5 is an equivalent to an embodiment of the top plate of the present invention.

Moreover, as shown in FIGS. 2 and 3, the speaker device 100 is so formed that the voice coil 7 wound around the voice coil bobbin 6 is disposed within the magnetic gap g. The voice coil bobbin 6 is freely vibratably supported by the frame 9 in the axial direction (the center axis direction of the center pole 1 (z-axis direction)), by virtue of a damper member 8 such as a spider member. The central portion of the diaphragm 10 is fixed in the vicinity of the upper end of the voice coil bobbin 6, while the outer edge portion of the diaphragm 10 is connected to the inner circumferential portion of the frame 9 through an edge member 12. Further, on one side of the top plate 5 facing the diaphragm 10 there is provided a heat dissipating member which can be used to fix the top plate 5 and release a heat of the top plate 5.

The yoke 3 is disposed in the central portion of the speaker device 100. In practice, the yoke 3 of the present embodiment is formed of a magnetic material such as iron. In more detail, the yoke 3 includes a cylindrical center pole 1 uprightly standing in the central portion of the speaker device 100, and a bottom yoke 2 which is a radially enlarged portion extending in the radial direction from the base end of the yoke 3 facing away from the diaphragm 10. On the outer periphery of the bottom yoke 2 facing the diaphragm 10, there is formed a flat portion 2a mounting the magnet 4. In this way, the annular magnet 4 having a rectangular cross section in the radial direction can be mounted on the flat portion 2a, being coaxial with the center pole 1. Then, the top plate 5 is mounted on one side of the magnet 4 facing the diaphragm 10 in a coaxial relation with the center pole 1.

As described above, the magnet 4 of the present embodiment has the first magnet piece 41 and the second magnet piece 42 which are arranged one above the other in a manner such that the directions of their magnetic moments become equal to each other. Here, the first magnet piece 41 is an equivalent to an embodiment of the first annular magnet of the present invention, the second magnet piece 42 is an equivalent to an embodiment of the second annular magnet of the present invention, with the inner diameter r411 of the first magnet piece 41 being larger than the inner diameter r421 of the second magnet piece 42. Further, in the present embodiment, the outer diameter r412 of the first magnet piece 41 and the outer diameter 422 of the second magnet piece 42 are set at approximately the same length. Namely, a distance r1 between the outer peripheral surface 1a of the center pole 1 and the inner circumferential surface 41c of the first magnet piece 41 is smaller than a distance between the outer peripheral surface 1a of the center pole 1 and the inner circumferential surface 42c of the second magnet piece 42. Moreover, the length L41 of the first magnet piece 41 in the axial direction (z-axis direction) is set to be at approximately the same length as the second magnet piece 42 in the axial direction.

The top plate 5 is formed of a magnetic material such as iron. In fact, the top plate 5 has a cylindrical bent portion 502 bending from a radial direction rectangular section portion 501 having a surface 51A facing the second annular magnet 42, and facing between the inner circumferential surface 42c of the second annular magnet 42 and the center pole 1, and separated a predetermined interval from the inner circumferential surface 42c of the second annular magnet 42. Then, among the bent portion 502 of the top plate 5, a part (an inner circumferential surface 5c) facing the magnetic gap g is formed (along the center axis c) into a width L1 larger than the winding width w7 of the voice coil 7. In practice, such a width L1 is set to be substantially equal to or larger than a vibration range of the voice coil bobbin 6.

A front end 521 of the bent portion 502 is disposed from the vicinity of a plate side corner portion 41e of an inner edge portion 41d of the first annular magnet 41, and located on the plate side by being separated a predetermined interval g45 from the corner portion 41e.

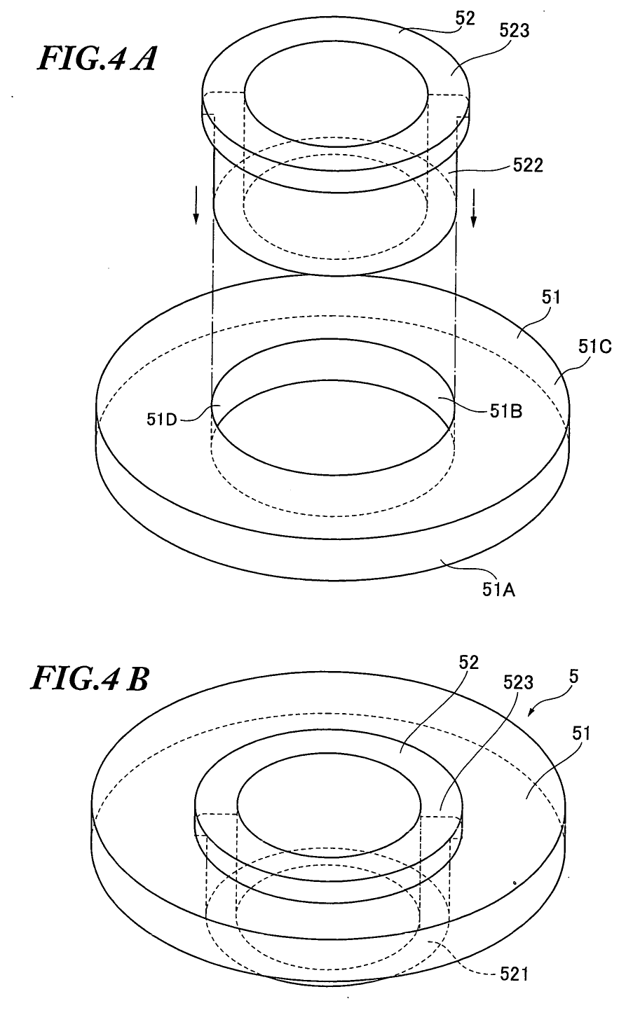

FIG. 4 is a view showing the top plate of the speaker device 100 illustrated in FIGS. 2 and 3. FIG. 4A is an exploded perspective view showing the top plate, and FIG. 4B is a perspective view showing the top plate which has been assembled. In the present embodiment, as shown in FIGS. 2 to 4A and 4B, the top plate 5 has a first piece 51 and a second piece 52 which can be assembled together to form a desired plate. In the following, description will be given to explain each element forming the top plate.

As shown, the first piece 51 has a large diameter hole 51B formed in the center thereof, thereby forming a ring-shaped thin plate. The first piece 51 has an outer peripheral surface 51A facing the second magnet piece 42. Further, the first piece 51 is so formed that its radial direction section has a long and narrow rectangular shape, has a uniform thickness in the axial direction, thereby forming a radially extending circular plate. In more detail, the first piece 51 has a radial direction section which is so formed that its radial direction size W2 is larger than its axial direction size L2.

The second piece 52 includes a cylindrical portion 522 extending in the axial direction and an engaging portion 523. In more detail, the cylindrical portion 522 has a large diameter and a small thickness, presenting a long and narrow rectangular shape in its cross section, thereby forming a cylinder member having a uniform thickness W1 in the radial direction and extending in the axial direction. As shown in FIG. 3, the second piece 52 has, on its inner circumferential surface, a magnetic gap facing surface 5f facing the magnetic gap g. In the radial direction cross section, the magnetic gap facing surface 5f has an axial direction size L1 which is larger than the radial direction size W1. The engaging portion 523 is bent from the outer circumferential surface of the cylindrical portion 522 towards the first piece 51, forming an annular protruding portion which can be engaged with the first piece 51, in a manner shown in FIGS. 4a and 4b.

By virtue of the inner circumferential surface of the through hole 51B of the first piece 51 and its vibration side large surface 51C, a corner 51D is formed corresponding to the inner circumference of the diaphragm 10, serving as an engaging portion for an engagement between the first piece 51 and the engaging portion 523 of the second piece 52. As shown in FIG. 4B, the two engaging portions are combined with each other so as to effect a mutual positioning. By virtue of the corner portion 51D, the annular inner edge upper surface portion of the first piece 51 is tightly fit (in the axial direction) against the underside of the engaging portion 523 of the second piece 52, and the inner circumferential surface of the first piece 51 is tightly fit (in the radial direction) with the outer circumferential surface of the second piece 52. Here, a first extension length L3 of the second piece 52 extending beyond the first piece 51 towards the diaphragm 10 is set to be shorter than a second extension length L4 of the second piece 52 extending away from the diaphragm 10.

As described above, as shown in FIGS. 2 to 4, the first piece 51 and the second piece 52 of the present embodiment are arranged in a manner such that the annular inner edge upper surface portion of the first piece 51 is tightly fit (in the axial direction) against the underside of the engaging portion 523 of the second piece 52, and the inner circumferential surface of the first piece 51 is tightly fit (in the radial direction) with the outer circumferential surface of the second piece 52. However, it is usually difficult to perform a processing to tightly fit together the two cylindrical members in the radial direction. On the other hand, the first piece 51 and the second piece 52 are also allowed not to be tightly fit to each other in the radial direction, but allowed to be combined with each other magnetically. Preferably, the first piece 51 and the second piece 52 are combined with each other through surfaces having magnetically large areas. For this reason, it is preferable that both the contacting surfaces in the axial direction and the contacting surfaces in the radial direction are tightly fit to each other. Alternatively, when some gaps are formed between the two pieces, it is preferable that these gaps are filled with a magnetic material.

Here, the so-called magnetic combination is an equivalent to an arrangement in which one material is flux-transferably combined with another material. For example, it is possible for one material to get an indirect contact with another material through an adhesive layer having a magnetism.

Here, the first piece 51 and the second piece 52 are bonded to each other through an adhesive agent (not shown) applied between the inner circumferential surface of the first piece 51 and the outer circumferential surface of the second piece 52. The first piece 51 directly mounted on the magnet 4 is bonded to the magnet 4 through an adhesive agent. Further, the heat dissipating member 11 made of a non-magnetic material such as aluminum or the like having an acceptable thermal conductivity is disposed on the top plate 5 close to the diaphragm 10. Preferably, such a heat dissipating member 11 is a non-magnetic material so that it will not disturb the magnetic circuit.

A part of the inner portion of the frame 9 extends to an open end of the first piece 51, while the dissipating member 11 is formed in a manner such that its contacting portion 11a formed at the front end thereof is in contact with the open end of the first piece 51. The contacting portion 11a is formed with a through hole in the axial direction, while a screw hole is formed in the first piece 51 at a position corresponding to the through hole. The heat dissipating member 11 is fixed by fixing a bolt 14 in the screw hole on the first piece 51. In fact, the heat dissipating member 11 can serve as heat dissipating means for releasing the heat of the top plate 5 and for fixing the top plate 5 on the magnet 4.

Between the outer peripheral surface 1a of the center pole 1 and the inner circumferential surface 5c of the top plate 5, there is formed a magnetic gap g along the entire circumference. In detail, such a magnetic gap g is formed over the outer peripheral surface of the center pole 1, extending along the outer peripheral surface of the center pole 1 in the axial direction. Namely, the magnetic gap g is formed in a cylindrical shape. A voice coil 7 is wound around the outer peripheral surface of an elongated thin thickness cylindrical voice coil bobbin 6 and located within the magnetic gap g. In practice, the voice coil bobbin 6 is supported through one end thereof by the frame 9 through the spider 8 which is a damper member.

In this way, the voice coil 7 can be provided in a manner such that it can vibrate within the magnetic gap g in the axial direction of the center pole 1. In detail, the foregoing end of the voice coil bobbin 6 is connected with the inner circumference of the so-called cone type diaphragm. The frame 9 has a cylindrical shape and tapered to some extent. The bottom of the frame 9 is formed with a screw hole for a bolt to insert therethrough. A fixing plate for supporting the yoke 3 from the backside thereof is fixed on the frame 9.

Moreover, as shown in FIG. 2, a center pole piece 15 having substantially the same diameter as the center pole 1 is fixed on the center pole 1 within the voice coil bobbin 6, by virtue of a bolt 16.

The speaker device 100 having the above-discussed structure is provided such that once a signal current flows into the voice coil 7 through a terminal section (not shown), the voice coil bobbin 6 will move in the axial direction (z-axis direction) by virtue of an electromagnetic force generated in the voice coil 7 in connection with the magnetic flux of the magnet 4. Actually, the movement of the voice coil bobbin 6 will propagate as a vibration of the diaphragm 10 and is outputted outwardly as an acoustic sound.

At this time, since the speaker device 100 is equipped with the top plate 5 (so-called long plate) in which an inner circumferential surface 5c of the second piece 52 has been made larger than the winding width W7 of the voice coil 7, it is possible to form a uniform flux density distribution in a wide region within the magnetic gap g. Further, since there have been provided the first magnet 41 and the second magnet 42, it is possible to obtain a magnetic force which is stronger than a conventional arrangement in which only one annular magnet is used, thereby preventing a reduction in the flux density when using the long plate.

As described above, the speaker device 100 includes the first magnet 41 having the first inner diameter r411 disposed on the bottom yoke 2, and the second magnet 42 having the second inner diameter r421 which is larger than the first inner diameter r411. The top plate 5 has a cylindrical bent portion 502 bending from a radial direction rectangular section portion 501 having a surface 51A facing the second annular magnet 42, and facing between the inner circumferential surface 42c of the second annular magnet 42 and the center pole 1, and separated a predetermined interval from the inner circumferential surface 42c of the second annular magnet 42. A front end 521 of the bent portion 502 is disposed from the vicinity of a plate side corner portion 41e of an inner edge portion 41d of the first annular magnet 41, and located on the plate side by being separated a predetermined interval g45 from the corner portion 41e. In this way, even if a long plate is employed, there will be no un-useful space formed within the magnetic circuit, thereby improving a space efficiency of the magnetic circuit.

### Second Embodiment

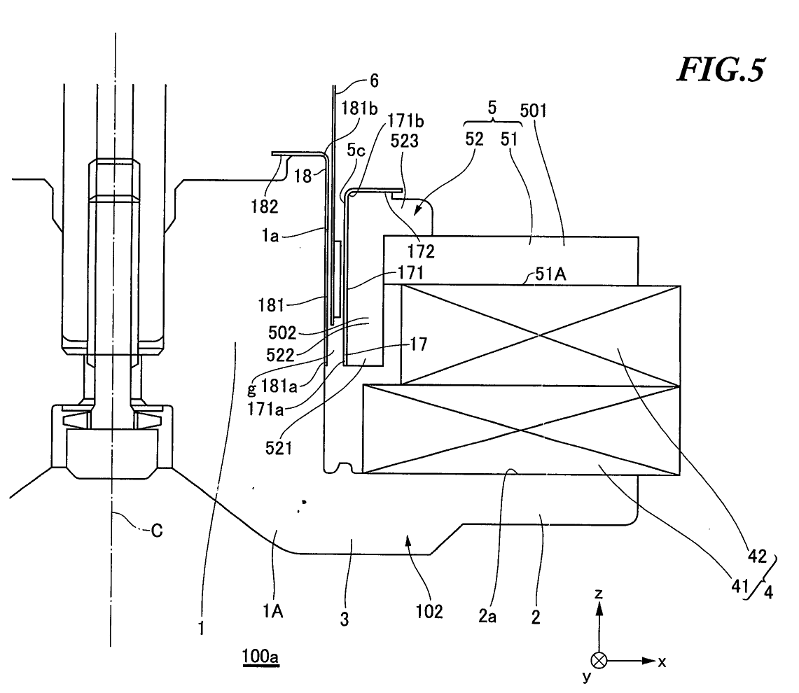

FIG. 5 is a sectional view showing a speaker device 100a formed according to a second embodiment of the present invention. However, the following description will not explain the structure, operation and effect which are the same as the foregoing first embodiment.

In a conventional speaker device, when a signal current containing a high frequency component flows into the voice coil 7, once a high frequency component such as a frequency component having a frequency of for example 100 Hz or more is inputted from the voice coil 7, an AC flux will be generated. Such an AC flux is collected and distributed in the vicinity of a magnetic gap G, more specifically in the center pole 1 and the top plate 5 near the magnetic gap G. Conventionally, materials forming the center pole 1 and the top plate 5 have, as their magnetic property, a nonlinear nature such as a hysteresis loop (minor loop). For this reason, an eddy current generated by an AC flux will receive an influence based on the minor loop, causing a distortion in an electric current flowing into the voice coil, thus resulting in a distortion in a reproduced sound. In particular, with regard to a speaker device including the long plate having the above-described structure, a distortion caused due to an AC flux will be relatively large.

For this reason, as shown in FIG. 5, the speaker device 100a of the present embodiment is fabricated in a manner such that on a part (inner circumferential surface 5c) of the bent portion 502 of the top plate 5 facing the magnetic gap g and/or on the outer peripheral surface 1a of the center pole 1, there is formed a short-circuit ring consisting of a non-magnetic and electrically conductive material. In the present embodiment, short-circuit rings consisting of a non-magnetic material are provided in both of the above positions, so that a distortion caused by an AC flux is greatly reduced.

In detail, as shown in FIG. 5, the speaker device 100a has a short-circuit ring 17 consisting of a non-magnetic material such as aluminum or copper, which is provided on part of the bent portion 502 of the top plate 5 facing the magnetic gap g. The speaker device 100a also has a cap (short-circuit ring) 18 consisting of a non-magnetic material which is located on the outer peripheral surface 1a of the center pole 1. In the following, description will be given to explain various essential elements with reference to the accompanying drawings.

Further, as shown in FIG. 5, the short-circuit ring 17 has a cylindrical portion 171 and a bent portion 172. The cylindrical portion 171 is formed along a part (inner circumferential surface 5c) of the bent portion 502 facing the magnetic gap g. The lower end portion 171a of the cylindrical portion 171 is located at a generally front end portion 521 of the bent portion 502. Here, the bent portion 172 is bending from the upper end portion 171b of the short-circuit ring 17 and further bending outwardly in the radial direction. Namely, the short-circuit ring 17 presents an inverted L-shaped cross section. Moreover, the short-circuit ring 17 is electrically connected to the top plate 5.

As shown in FIG. 5, the cap 18 includes a cylindrical portion 181 and a bent portion 182. The cylindrical portion 181 is disposed along the outer peripheral surface 1a of the center pole 1. The lower end portion 181a is located in a position facing the front end portion 521 of the top plate 5. The bent portion 182 is bending from an upper end portion towards the center axis. Namely, the cap 18 presents an inverted L-shaped cross section. Moreover, the cap 18 is electrically connected to the center pole 1.

Here, the short-circuit ring 17 and the cap 18 will function as a secondary winding of the voice coil 7, and disposed on the top plate 5 and the center pole 1 so as to reduce an inductance of the voice coil 7. For example, it is possible to reduce a distortion, such as a secondary, a tertiary, or a higher order harmonic distortion. In more detail, with regard to the magnetic materials for forming the center pole 1 and the top plate 5, even if the magnetic property is non-linear, a changing amount of the inductance will become small, thereby reducing a distortion.

As described above, the speaker device 10a of the present embodiment is fabricated in a manner such that on a part (inner circumferential surface 5) of the bent portion 502 of the top plate 5 facing the magnetic gap g and/or on the outer peripheral surface 1a of the center pole 1, there is formed a short-circuit ring consisting of a non-magnetic and electrically conductive material. As a result, it is possible to reduce a distortion of an electric current flowing into the voce coil, thereby reducing a distortion in a reproduced sound.

Further, as discussed above, the speaker device 100a employs a long plate, a short-circuit ring 17 made of a copper, as well as a cap 18 made of a copper. Moreover, similar to the foregoing first embodiment, the speaker device 100a uses a first magnet 41 and a second magnet 42 which have different inner diameters and laid one on top of the other. In this way, it is possible to obtain a maximum magnetic capacity within a limited space, thereby ensuring an adequate flux density Bg within the magnetic gap.

[A Comparison of a Vibrating Amount of a Vibrating System of a Speaker Device]

In order to confirm the performance of a speaker device formed according to one embodiment of the present invention, the inventors of the present invention have measured a vibrating amount and a frequency characteristic of a conventional speaker device and those of the speaker device 100a of the present invention, thereby carrying out a desired comparison.

The conventional speaker device has its top plate made in a thickness which is smaller than the winding width of its voice coil, while its flux distribution is formed along the axial direction of its top plate on the outside thereof in a vertically non-symmetrical manner.

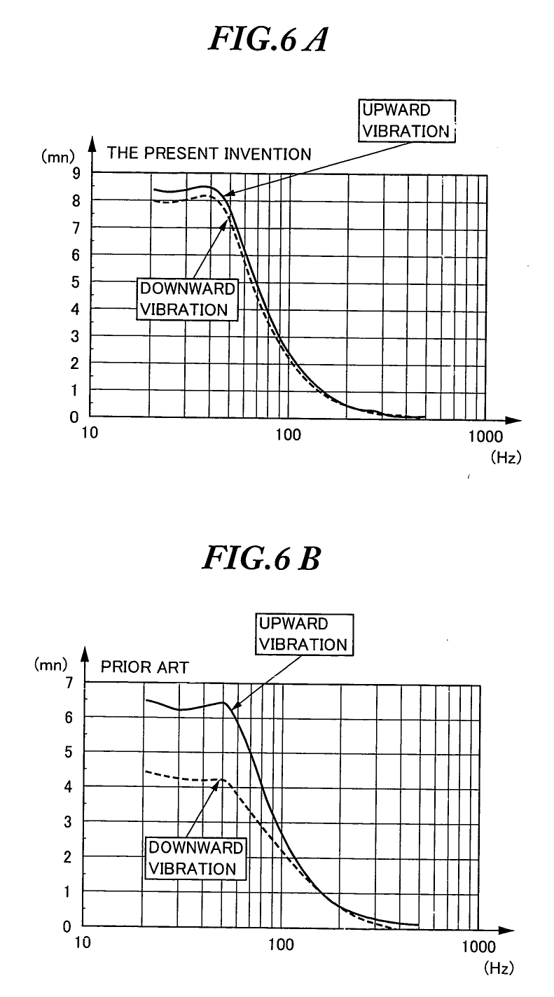

FIG. 6 provides graphs showing a frequency characteristic and a vibrating amount of a speaker device formed according to one embodiment of the present invention and those of a conventional speaker device. FIG. 6A is a graph showing a vibrating amount of a diaphragm of the speaker device according to the second embodiment of the present invention, FIG. 6B is a graph showing a vibrating amount of a diaphragm of the conventional speaker device. In these graphs, each horizontal axis represents a frequency and each vertical axis represents a vibrating amount, each solid line represents a vibrating amount (upward vibrating amount) moving from a standard position (a predetermined position) to an upper side (the front side), while each broken line represents a vibrating amount (downward vibrating amount) moving from a standard position (a predetermined position) to a lower side (the rear side).

As shown in FIG. 6B, with regard to a conventional speaker, an upward vibrating amount is substantially constant from a frequency 20 Hz to a frequency 50 Hz, but rapidly decreases from a frequency 50 Hz to a frequency 400 Hz. Similarly, a downward vibrating amount is substantially constant from a frequency 20 Hz to a frequency 50 Hz, but rapidly decreases from a frequency 50 Hz to a frequency 400 Hz.

On the other hand, as shown in FIG. 6A, a speaker device formed according to an embodiment of the present invention is so fabricated that a difference between an upward vibrating amount and a downward vibrating amount is smaller than that of a conventional speaker device.

As understood from the above comparison, the speaker device 100a of the present invention is different from the conventional speaker device in the following facts. Namely, the conventional speaker device shows a relatively large difference between an upward vibrating amount and a downward vibrating amount, while the speaker device 100a of the present invention shows an extremely small difference between an upward vibrating amount and a downward vibrating amount, thereby confirming that a vibration of the diaphragm is generally symmetrical about the standard position (a predetermined position).

[A Comparison of Various Frequency Characteristics of Speaker Device]

In order to confirm various performances of the speaker device formed according to the second embodiment of the present invention, the inventors of the present invention have measured the frequency characteristics of the various performances. In more detail, various frequencies have been measured to perform a comparison between the speaker device 10a of the second embodiment and the speaker device 100 of the first embodiment which is not equipped with a copper cap and a copper short-circuit ring.

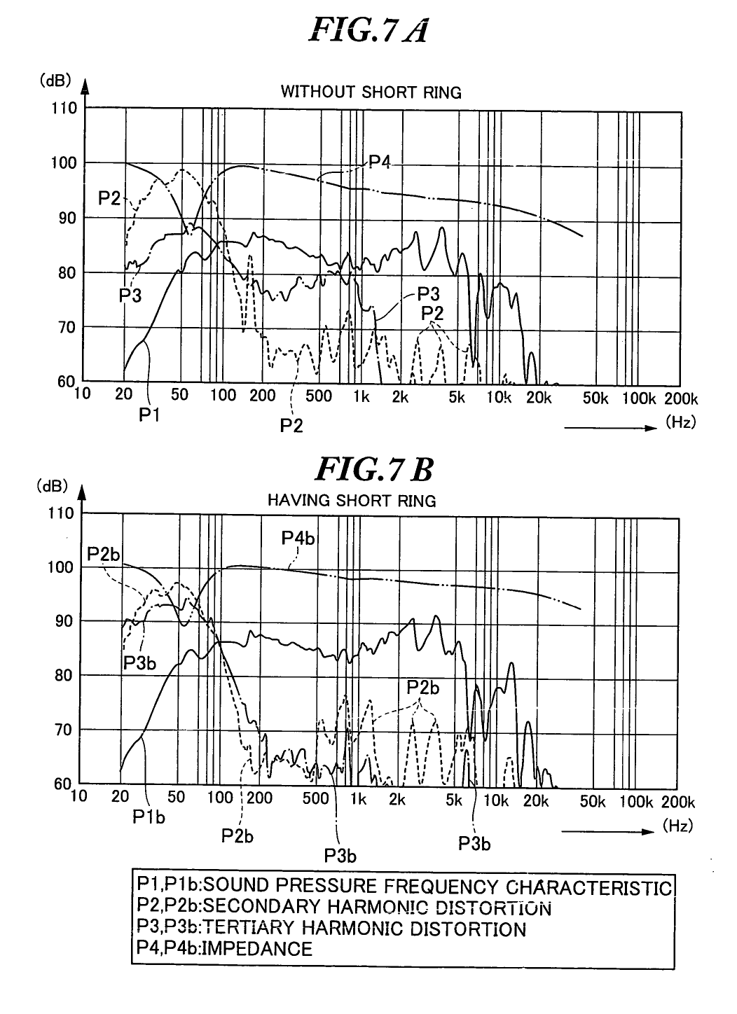

FIG. 7 provides graphs showing acoustic frequency characteristics of speaker devices. FIG. 7A shows an acoustic frequency characteristic of a conventional speaker device, and FIG. 7B shows an acoustic frequency characteristic of a speaker device of the present invention. In these graphs, each solid line represents a sound pressure frequency characteristic, each broken line represents a frequency characteristic of a secondary harmonic distortion, each chain line represents a frequency characteristic of a tertiary harmonic distortion, each two-dot chain line represents an impedance curve. In FIGS. 7A and 7B, the distortion amounts (a secondary harmonic distortion and a tertiary harmonic distortion) are represented based on 30 dB-raising. For example, as shown in FIG. 7A, the secondary harmonic distortion at a frequency of 50 Hz is actually 69 dB.

As shown in FIGS. 7A and 7B, the speaker device 100a is so fabricated that within a frequency range of 2000-5000 Hz its sound pressure level p1 represented by a solid line is larger than the sound pressure level p1b of the speaker device 100. Further, in the speaker device 100a, the secondary harmonic distortion p2 represented by a broken line reaches a peak near a frequency of 170 Hz, but is greatly lower than the secondary harmonic distortion p2b of the speaker device 100. Moreover, the speaker device 100a is so fabricated that within a frequency range 100-2000 Hz, the tertiary harmonic distortion p3 represented by a chain line has a level which is greatly lower than the tertiary harmonic distortion p3b of the speaker device 100. In addition, the speaker device 100a is so fabricated that within a frequency range from 500 Hz to 40 kHz its impedance p4 represented by a two-dot chain line is greatly lower than the impedance of the speaker device 100.

As described above, since the speaker device 100a formed according to the second embodiment has the short-circuit ring 17 and the cap 18, it has been confirmed that a secondary harmonic distortion and a tertiary harmonic distortion have been greatly reduced as compared with the speaker device 100 of the first embodiment.

However, the present invention should not be limited to the above-described embodiment. For example, it is possible to combine together several of the above-described embodiments of the present invention.

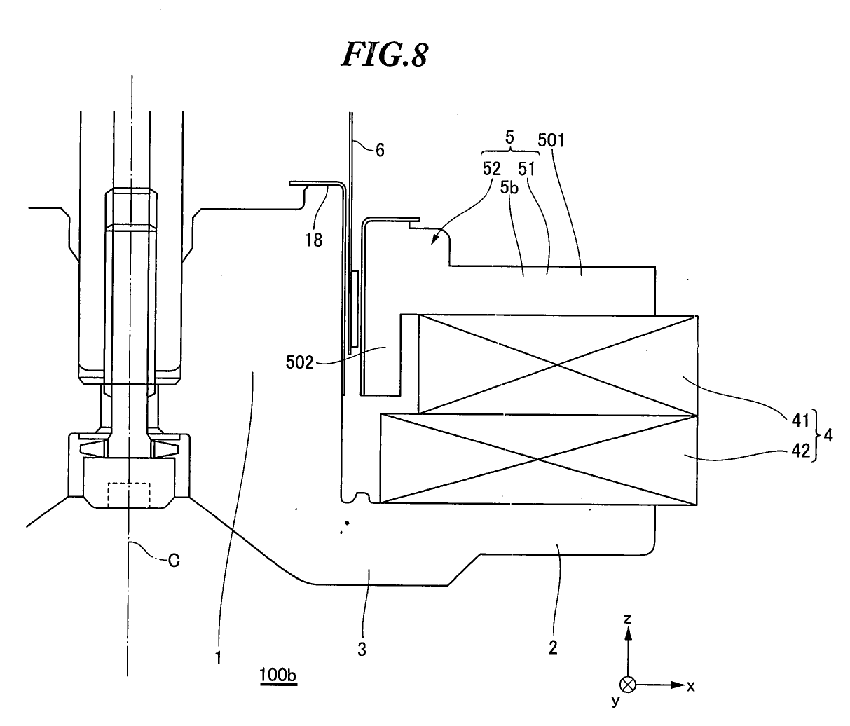

Although the above-described embodiments have indicated that the top plate 5 includes the first piece 51 and the second piece 52, this should not form any limitation to the present invention. For example, as shown in FIG. 8, the speaker device 100 is allowed to employ a top plate 5b in which the first piece 51 and the second piece 52 have been integrally formed together.

Further, although the above-described embodiments have shown that the second piece 52 of the top plate 5 includes a cylindrical portion 522 and an engaging portion 523, this should not form any limitation to the present invention. For example, it is allowed to use only the cylindrical portion 522 without the engaging portion 523.

Moreover, the above-described embodiments have employed a magnetic circuit equipped with the magnet 4 including the two magnet pieces 41 and 42 having different inner diameters and placed one on top of the other. At this time, a closed magnetic circuit is formed starting from the inner circumferential portion of the first magnet piece 41, arriving at the top plate 5 and the magnet 4, by way of the front end portion of the second piece 52 of the top plate 5 close to the inner circumferential portion thereof. As a result, there is a possibility that the magnitude of the flux between the center pole 1 and the top plate 5 will decrease. In view of this, if the above factors are taken into account so that positional relations and shapes or the like of the magnet pieces 41 and 42, the top plate 5, and the center pole 1 are all set at their optimum values, it is possible to increase the flux between the center pole 1 and the top plate 5.

As described above, the speaker device 100 has a magnetic circuit 102 including: the yoke 3 integrally formed with the center pole 1 uprightly standing in a generally central portion of the speaker device 100 and the bottom yoke 2 extending outwardly in the radial direction from the base end of the center pole 1; the annular magnet 4 formed concentrically with the center pole 1 on the bottom yoke 2; and the annular top plate 5 disposed on the magnet 4. The voice coil 7 wound around the voice coil bobbin 6 fixed with the diaphragm 10 is freely vibratably supported in the axial direction of the center pole 10 within the magnetic gap g formed between the center pole 1 and the yoke 3. Moreover, the speaker device 100 has the first magnet 41 having a first inner diameter r411 and disposed on the bottom yoke 2, and the second magnet 42 having a second inner diameter r421 larger than the first inner diameter r411 and disposed on the first magnet 41. The top plate 5 has a cylindrical bent portion bending from a radial direction rectangular section portion having a surface facing the second annular magnet 42, and facing between the inner circumferential surface 42c of the second annular magnet 42 and the center pole 1, and separated a predetermined interval from the inner circumferential surface 42c of the second annular magnet 42. The front end 521 of the bent portion 502 is disposed from the vicinity of a plate side corner portion 41e of an inner edge portion 41d of the first annular magnet 41, and located on the plate side by being separated a predetermined interval from the corner portion 41e. In this way, even if the speaker device employs a long plate, it is still possible to improve a space efficiency of the magnetic circuit, without forming an un-useful space within the magnetic circuit. Besides, even if the speaker device employs a long plate, it is still possible to realize a high flux density within the magnetic gap of the magnetic circuit.

Moreover, the speaker device 100a has a short-circuit ring formed of a non-magnetic conductive material on part (inner circumferential surface 5c) of the bent portion 502 of the top plate 5 facing the magnetic gap g and/or on the outer peripheral surface 1a of the center pole 1. Therefore, it is possible to reduce a distortion of an electric current flowing into the voice coil, thereby reducing a distortion in a reproduced sound. Further, the speaker device 100a has employed a long plate, a copper short-circuit ring 17 and a copper cap 18. Besides, similar to the first embodiment, since the speaker device employs the first magnet 41 and the second magnet 42 having different inner diameters and placed one on top of the other, it is possible to obtain a maximum magnet capacity under a restriction of a limited size, thereby ensuring an adequate flux density Bg within the magnetic gap g.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A speaker device having a magnetic circuit including: a yoke integrally formed with a center pole uprightly standing in a generally central position of the speaker device and a bottom yoke extending outwardly in a radial direction from a base end of the center pole; an annular magnet provided concentrically with the center pole on the bottom yoke; and an annular plate disposed on the annular magnet,
wherein a voice coil wound around a voice coil bobbin fixed with a diaphragm is freely vibratably supported in an axial direction of the center pole within a magnetic gap formed between the center pole and the yoke,
wherein said magnet includes a first annular magnet having a first inner diameter and disposed on the bottom yoke, and a second annular magnet having a second inner diameter larger than the first inner diameter and disposed on the first annular magnet,
wherein said plate has a cylindrical bent portion bending from a radial direction rectangular section portion having a surface facing the second annular magnet, and facing between an inner circumferential surface of the second annular magnet and the center pole, and separated a predetermined interval from the inner circumferential surface of the second annular magnet,
wherein a part of the bent portion of the plate facing the magnetic gap is formed along the center axis in a length longer than a winding width of the voice coil,
wherein a front end of the bent portion is disposed from the vicinity of a plate side corner portion of an inner edge portion of the first annular magnet, and located on the plate side by being separated a predetermined interval from the corner portion.

2. A speaker device having a magnetic circuit including: a yoke integrally formed with a center pole uprightly standing in a generally central position of the speaker device and a bottom yoke extending outwardly in a radial direction from a base end of the center pole;
an annular magnet provided concentrically with the center pole on the bottom yoke; and an annular plate disposed on the annular magnet,
wherein a voice coil wound around a voice coil bobbin fixed with a diaphragm is freely vibratably supported in an axial direction of the center pole within a magnetic gap formed between the center pole and the yoke,
wherein said plate has a cylindrical bent portion bending from a radial direction rectangular section portion having a surface facing the magnet, and facing between an inner circumferential surface of the magnet and the center pole, and separated a predetermined interval from the inner circumferential surface of the magnet,
wherein a part of the bent portion of the plate facing the magnetic gap is formed along the center axis in a length longer than a winding width of the voice coil,
wherein, a short-circuit ring formed of a non-magnetic conductive material is provided on part of the plate facing the magnetic gap and/or on the outer peripheral surface of the center pole.

3. The speaker device according to claim 2, wherein the short-circuit ring is made of aluminum or copper.

4. The speaker device according to Claim 2,
wherein said magnet includes a first annular magnet having a first inner diameter and disposed on the bottom yoke, and a second annular magnet having a second inner diameter larger than the first inner diameter and disposed on the first annular magnet,
wherein said plate has a cylindrical bent portion bending from a radial direction rectangular section portion having a surface facing the second annular magnet, and facing between an inner circumferential surface of the second annular magnet and the center pole, and separated a predetermined interval from the inner circumferential surface of the second annular magnet,
wherein a front end of the bent portion is disposed from the vicinity of a plate side corner portion of an inner edge portion of the first annular magnet, and located on the plate side by being separated a predetermined interval from the corner portion.

5. The speaker device according to claim 1 or 2, wherein said plate comprises:
a first piece which is a ring-shaped thin plate having a surface facing the second annular magnet; and
a second piece which is in a cylindrical shape adapted to engage with the inner circumferential surface of the first piece, has a length longer than a thickness of the first piece in its center axis direction, and is equipped with an inner circumferential surface facing the magnetic gap.
